(19) United States
(12) Patent Application Publication
(10) Pub. No.: US 2026/0095621 A1
(43) Pub. Date: Apr. 2, 2026

(54) ARTIFICIAL INTELLIGENCE (AI) AUDIO ENHANCEMENT

(71) Applicant: Roku, Inc., San Jose, CA (US)

(72) Inventors: Juhi Checker, Sunnyvale, CA (US); Sharada Palasamudram Ashok Kumar, San Jose, CA (US); Jaime Martinez, Austin, TX (US); Martin Dahl Kilt, Galten (DK)

(73) Assignee: Roku, Inc., San Jose, CA (US)

(21) Appl. No.: 18/901,021

(22) Filed: Sep. 30, 2024

(51) Int. Cl. H04N 21/439; G10L 21/10

(52) U.S. Cl. CPC H04N 21/4394; G10L 21/10

(57) ABSTRACT

Disclosed herein are system, apparatus, device, method and/or computer program product aspects, and/or combinations and sub-combinations thereof, for classifying audio signals and dynamically adjusting an audio processing based at least on the classification to create high quality audio. An example aspect operates by a computer-implemented method including receiving, by at least one computer processor, an audio signal associated with a content. The method further includes preprocessing the audio signal to generate preprocessed audio data and determining an audio class using the preprocessed audio data. The audio class indicates an audio mode for playing the audio signal. The method further includes outputting the audio signal and the audio class.

### BACKGROUND

### Field

This disclosure is generally directed to methods and systems for classifying audio signals and dynamically adjusting an audio processing based at least on the classification to create high quality audio.

### SUMMARY

Provided herein are system, apparatus, article of manufacture, method and/or computer program product aspects, and/or combinations and sub-combinations thereof, for using an artificial intelligence model for classifying audio signals in to a set of classes and using the classification to dynamically adjust an audio processing of the audio signals.

An example aspect operates by a computer-implemented method. The method receiving, by at least one computer processor, an audio signal associated with a content. The method further includes preprocessing the audio signal to generate preprocessed audio data and determining an audio class using the preprocessed audio data. The audio class indicates an audio mode for playing the audio signal. The method also includes outputting the audio signal and the audio class.

In some aspects, determining the audio class includes using an artificial intelligence (AI) classification model to classify the preprocessed audio data and to determine the audio class. The AI classification model can include one or more gated recurrent unit (GRU) blocks. In some aspects, determining the audio class further includes determining a number of the one or more GRU block used for classifying the preprocessed audio data.

In some aspects, preprocessing the audio signal includes at least one of generating audio samples from the audio signal, converting the audio signal from a time-domain to a frequency domain, or generating a spectrogram associated with the audio signal.

In some aspects, the audio class is used to determine one or more parameters for processing the audio signal after the audio classification. Additionally, or alternatively, the audio class is used to select a digital signal processing (DSP) algorithm for audio quality (AQ) enhancement of the audio signal. Additionally, or alternatively, the audio class is used to select one or more parameters of a digital signal processing (DSP) algorithm for audio quality (AQ) enhancement of the audio signal.

In some aspects, the audio class is used to select the audio mode of a media device or the audio mode of a display device for playing the audio signal.

In some aspects, determining the audio class includes using an artificial intelligence (AI) classification model in addition to metadata associated with the audio signal to classify the preprocessed audio data and to determine the audio class.

In some aspects, the method further includes determining a plurality of audio classes for the audio signal, where each one of the plurality of audio classes is associated with a portion of the audio signal in time.

An example aspect operates by a non-transitory computer-readable medium having instructions stored thereon that, when executed by at least one computing device, cause the at least one computing device to perform operations. The operations can include receiving an audio signal associated with a content. The operations further include preprocessing the audio signal to generate preprocessed audio data and determining an audio class using the preprocessed audio data. The audio class indicates an audio mode for playing the audio signal. The audio mode includes at least one of a music mode, a speech mode, a sports mode, a theatre mode, or a dialogue mode. The operations also include outputting the audio signal and the audio class.

An example aspect operates by a system including one or more memories and at least one processor each coupled to at least one of the one or more memories. The at least one processor is configured to perform operations including receiving an audio signal associated with a content. The operations further include preprocessing the audio signal to generate preprocessed audio data and determining an audio class using the preprocessed audio data. The audio class indicates an audio mode for playing the audio signal. The audio mode includes at least one of a music mode, a speech mode, a sports mode, a theatre mode, or a dialogue mode. The operations also include outputting the audio signal and the audio class.

### BRIEF DESCRIPTION OF THE FIGURES

The accompanying drawings are incorporated herein and form a part of the specification.

FIG. 1 illustrates a block diagram of a multimedia environment, according to some aspects.

FIG. 2 illustrates a block diagram of a streaming media device, according to some aspects.

FIG. 3 illustrates a block diagram of an example audio classifier, according to some aspects.

FIG. 4A illustrates one exemplary method for classifying audio signals, according to some aspects.

FIG. 4B illustrates one exemplary method for processing audio signals, according to some aspects.

FIG. 4C illustrates one exemplary method for setting an audio mode, according to some aspects.

FIG. 5 illustrates an example computer system that can be used for implementing various aspects.

In the drawings, like reference numbers generally indicate identical or similar elements. Additionally, generally, the left-most digit(s) of a reference number identifies the drawing in which the reference number first appears.

### DETAILED DESCRIPTION

A device such as a television (TV) has pre-defined audio modes such as speech, music, theatre, dialogue, and the like. When the device outputs an audio content (e.g., an audio signal associated with a video content), the device uses one of the audio modes for outputting the audio content. In most cases, a user of the device does not change the default audio mode that the device has come with. Even if a user manually changes the audio mode for an audio content, the manual switching is tedious and can include going through multiple steps using a remote control. This tedious manual switching is not easy for many consumer. Also, the users usually forget to manually switch between different audio modes.

Additionally, an audio content can include multiple different audio types within the audio content. If a user manually sets the audio mode at beginning of the paly of the audio content, audio types of the audio content changes during the play of the audio content without the audio mode being adapted accordingly. Therefore, setting a constant audio mode for the entire during of the audio content is not optimal. A metadata at the beginning of the audio content may include information regarding the audio type/mode of the audio content. But, using the metadata is costly and the metadata may not signal the changes in the audio type/mode during the entirety of the audio content.

Traditional audio quality (AQ) enhancement is done using digital signal processing (DSP) algorithms. The AQ enhancement can include, but is not limited to, speech clarity, speech detection, level management, and the like. These DSP algorithms directly operate on audio samples of the audio content. Currently, many DSP algorithms fail to detect what audio type/mode is being processed, which can lead to poor implementation of the DSP algorithms and the AQ enhancement.

Provided herein are system, apparatus, article of manufacture, method and/or computer program product aspects, and/or combinations and sub-combinations thereof, for classifying audio signals and dynamically adjusting an audio processing based at least on the classification to create high quality audio. For example, system, apparatus, article of manufacture, method and/or computer program product aspects, and/or combinations and sub-combinations thereof are provided for using an artificial intelligence model for classifying the audio signals in to a set of classes and using the classification to dynamically adjust the audio processing of the audio signals.

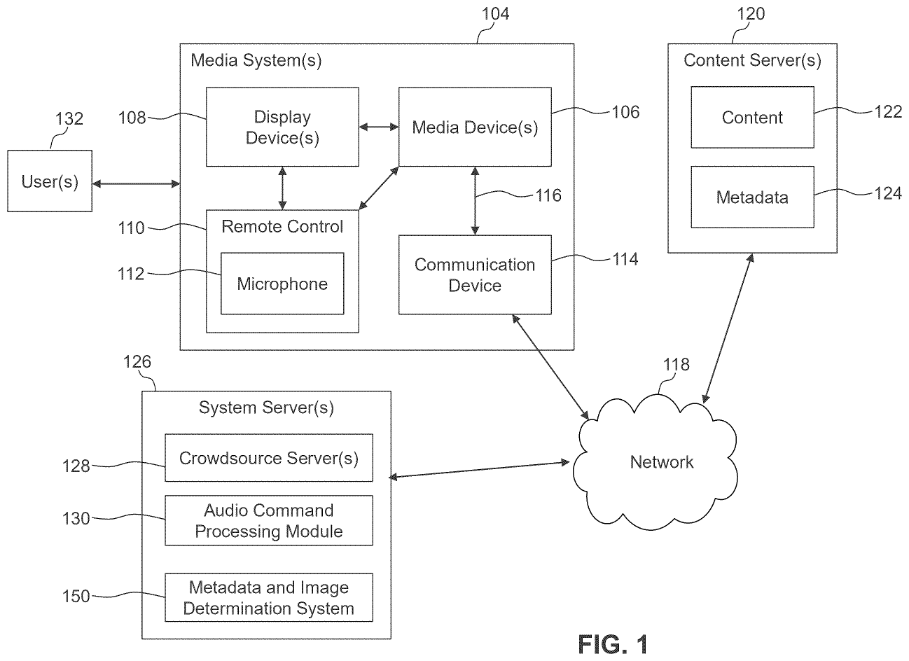

Various aspects of this disclosure may be implemented using and/or may be part of a multimedia environment 102 shown in FIG. 1. It is noted, however, that multimedia environment 102 is provided solely for illustrative purposes, and is not limiting. Aspects of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102 that can include a metadata and image determination system, according to some aspects. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IOT) device, and/or projector, to name just a few examples. In some aspects, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, where the link 116 may include wireless (such as WiFi) and/or wired connections.

In various aspects, the network 118 can include, without limitation, wired and/or wireless intranet, extranet, Internet, cellular, Bluetooth™, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, a laptop computer, an smartphone, a wearable device, on-screen controls, integrated control buttons, audio controls, or any combination thereof, to name just a few examples. In an aspect, the remote control 110 wirelessly communicates with the media device 106 and/or display device 108 using cellular, Bluetooth™, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some aspects, metadata 124 includes data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing aspects and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). In some aspects, the media device 106 may be audio responsive, and the audio data may represent verbal commands from the user 132 to control the media device 106 as well as other components in the media system 104, such as the display device 108.

In some aspects, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

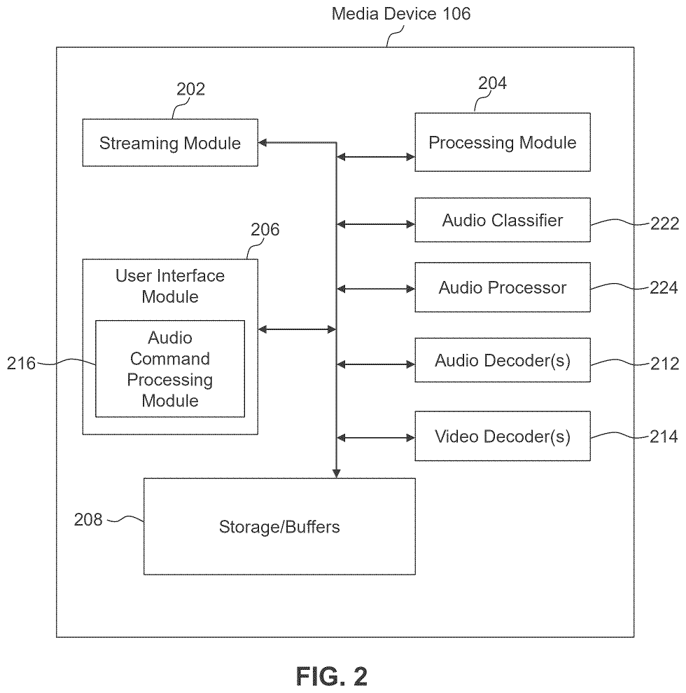

In some aspects, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

As discussed in more detail below, the media device 106, as one example, includes an audio classifier (e.g., the audio classifier 222 of FIG. 2). The media device 106 may be configured to classify audio signals and dynamically adjust an audio processing based at least on the classification. For example, the media device 106 may be configured to use an artificial intelligence (AI) model for classifying the audio signals in to a set of classes and use the classification to dynamically adjust the audio processing of the audio signals. Although the media device 106 is provided as one example for classifying audio signals and dynamically adjusting an audio processing based at least on the classification, other devices in the media system 104, in the content server 120, and/or the system server 126 can be used for classifying audio signals and dynamically adjusting the audio processing.

The media device 106 can use an AI model to take audio samples (also referred to herein as audio data) from an audio content as input and to classify every block into a set of classes. This set of classes can include, but is not limited to, speech, music, theatre, dialogue, sports, and the. The AI model has contextual understanding of the content (audio content and/or video content) being played and can classify the audio content into one or more of pre-determined classes. The result from AI model is then used to dynamically adjust the audio processing on a scene-by-scene basis. This AI model could be run on any hardware. Additionally, the AI model's results would be generic for all input (e.g., streaming, High-Definition Multimedia Interface (HDMI), or the like).

According to some aspects, the classification of the media device 106 reduces the dependency on metadata and traditional methods (like manual work) for switching audio mode. Additionally, the classification of the media device 106 optimizes the DSP enhancement implementation blocks. A model inference is at par with the DSP algorithms and can process very small audio samples (e.g., less than about 20 ms) and inference it in a short amount of time.

According to some aspects, the classification of the media device 106 uses AI models that are deployed on the edge device where no information will leave the device making it very secured. In some aspects, all of the classification operation of the media device 106 can be performed on the edge device (e.g., any hardware-independent of the platform) and on any type of audio input.

FIG. 2 illustrates a block diagram of an example media device 106, according to some aspects. Media device 106 may include a streaming module 202, processing module 204, storage/buffers 208, user interface module 206, audio classifier 222, and/or audio processor 224. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some aspects, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming aspects, the streaming module 202 may transmit the content to the display device 108 in real time or near real time as it receives such content from the content server(s) 120. In non-streaming aspects, the media device 106 may store the content received from content server(s) 120 in storage/buffers 208 for later playback on display device 108.

The audio classifier 222 is configured to receive audio signals. The audio signals can be associated with an audio content played by the media devices 106. Additionally, or alternatively, the audio signals can be associated with a video content that is being played by the media device 106. However, the audio signals can be associated with other content played by the media device 106. The audio classifier 222 is configured classify the audio signals. The classified audio signals can be stored in storage/buffers 208. Additionally, or alternatively, the classified audio signals can be sent to the audio processor 224. The audio processor 224 can use the classification of the audio classifier 222 and/or the classified audio signals to adjust one or more audio processing of the received audio signals. In some aspects, the audio decoder 212 and the audio processor 224 can be part of the same processing unit. In some aspects, the audio decoder 212 and the audio processor 224 can be part of the different processing units. In some aspects, the audio decoder 212 can be part of the audio processor 224.

According to some aspects, the audio decoder 212 uses an AI model for classifying the audio signals into a set of classes and use the classification to dynamically adjust the audio processing of the audio processor 224 and/or audio decoder 212. The audio decoder 212 uses an AI model to take the audio signals as input and to classify every block of the audio signals into a set of classes. This set of classes can include speech, music, theatre, dialogue, sports, and the. The audio decoder 212 has contextual understanding of the content (audio content and/or video content) being played and can classify the audio content into one or more of pre-determined classes. The result from the audio decoder 212 is then used to dynamically adjust the audio processor 224 and/or audio decoder 212 on a scene-by-scene basis.

### The Audio Classifier

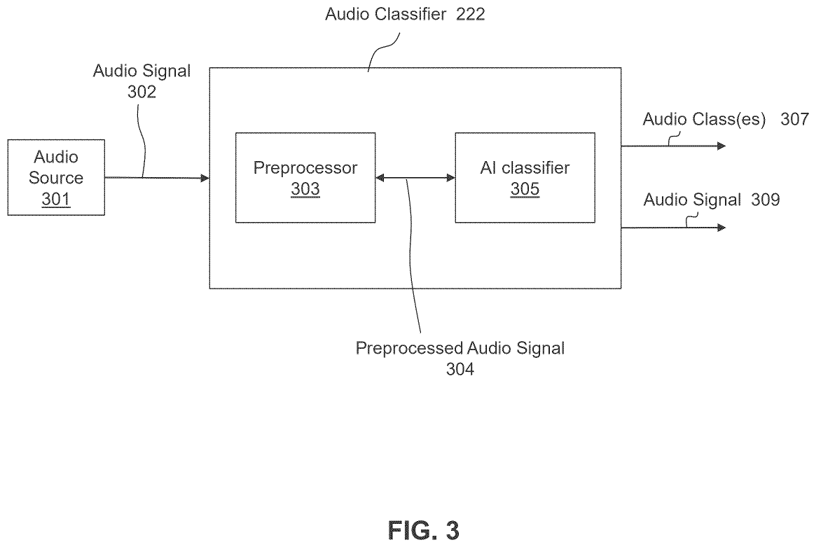

FIG. 3 illustrates a block diagram of an example audio classifier 222, according to some aspects. According to some aspects, the audio classifier 222 can include a preprocessor 303 and an AI classifier 305. However, the aspects of this disclosure are not limited to these examples, and the audio classifier 222 can include other systems and/or modules.

The audio classifier 222 can receive audio signal 302 from audio source 301. The audio source 301 can include a source of audio content, a source of video content, or the like. For example, the audio source 301 can be part of the content server 120 of FIG. 1. The audio signal 302 can include audio data (also referred to herein as audio samples). The audio signal 302 can also include metadata associated with the audio signal 302.

The audio signal 302 can be associated with one or more audio profiles (also referred to herein as audio modes). For example, the audio signal 302 can be associated with one or more of music mode, speech mode, sports mode, theatre mode, dialogue mode, or the like. Using the corresponding audio profile the audio signal 302 (or a portion of the audio signal 302) when the audio signal 302 is being played by, for example, media device 106 can enhance the user experience. The audio classifier 222 (for example sing the AI classifier 305) performs an AI audio classification on the audio signal 302 (or the preprocessed audio signal 304) in real time (or near real time). The results of the AI audio classification can be used to change the audio mode on, for example, the media device 106 and/or the display device 108 and/or can be used to enhance the audio signal processing of the audio processor 224 and/or audio decoder 212.

According to some aspects, the audio classifier 222 includes a preprocessor 303. The preprocessor 303 receives the audio signal 302 from the audio source 301. The preprocessor 303 can process the audio signal 302 before the AI classification is performed by the AI classifier 305. For example, the preprocessor 303 can sample the audio signal 302 to generate audio samples (also referred to herein as audio data). For example, the preprocessor 303 can convert the audio signal 302 from time-domain to frequency domain. As another example, the preprocessor 303 can generate spectrogram associated with the audio signal 302. For example, the preprocessor 303 is configured to generate a one dimensional array data from the audio signal 302.

The preprocessed audio signal 304 is input to the AI classifier 305. For example, a one dimensional array data (e.g., as part of the preprocessed audio signal 304) is input to the AI classifier 305. According to some aspects, the AI classifier 305 can include one or more gated recurrent unit (GRU) blocks. However, the AI classifier 305 can include other mechanisms in, for example, recurrent neural networks (RNNs). Additionally, or alternatively, the AI classifier 305 can include other AI and/or machine learning mechanisms configured to analyze the receive the preprocessed audio signal 304 (e.g., a one dimensional array data) and classify the audio signal 302 into one or more classifications. As discussed above, the classifications can include music, speech, sports, theatre, dialogue, or the like.

According to some aspects, the AI classifier 305 includes one or more GRU blocks. In some aspects, the number of the GRU blocks of the AI classifier 305 can be fixed for different audio signals 302. Additionally, or alternatively, the number of the GRU blocks of the AI classifier 305 can be different for different audio signals 302. For example, the preprocessor 303 can determine an initial parameter based on the information of an audio signal 302. The AI classifier 305 can use this initial parameter to determine the number of GRU blocks. In some aspect, the preprocessor 303 can use the metadata associated with the audio signal 302 to determine the initial parameter for choosing the number of the GRU blocks of the AI classifier 305.

According to some aspects, the number of the GRU blocks can be fixed during the preprocessing and AI classification of one audio signal 302. Additionally, or alternatively, the number of the GRU blocks can dynamically change during the preprocessing and AI classification of one audio signal 302. In some aspects, the number of the GRU blocks can be determine during the creating of the AI classifier 305.

According to some aspects, the preprocessor 303 and/or the AI classifier 305 can perform the preprocessing and/or the classification on audio samples from the audio signal 302. Additionally, or alternatively, the preprocessor 303 and/or the AI classifier 305 can perform the preprocessing and/or the classification on image samples generated from the audio samples from the audio signal 302. For example, the preprocessor 303 can include (or be coupled) to a converter configured to receive the audio samples of the audio signal 302 and generate image samples from the audio samples. The image samples are then used by the preprocessor 303 and/or the AI classifier 305 to classify the audio signal 302. In this example, the preprocessor 303 and/or the AI classifier 305 can include a computer vision based model. In some examples, the preprocessor 303 and/or the AI classifier 305 can include AI based image processing models. However, the image processing models can require more expansive resources and introduce more delay.

According to some aspect, the preprocessor 303 and/or the AI classifier 305 are configured to use a specific amount of audio samples from the audio signal 302. In some examples, the preprocessor 303 and/or the AI classifier 305 can use about a 20 ms audio sample from the audio signal 302 for preprocessing and classification. Other sample sizes (for example about 5 ms, about 10 ms, about 15 ms, about 25 ms, about 30 ms, or so) can be used for preprocessing and classification. In some examples, a tradeoff between the amount of data to be used and the processing time for the preprocessing and classification is used to determine the sample size of the audio samples.

According to some aspects, the preprocessor 303 and/or the AI classifier 305 are configured to analyze and classify the audio signal 302 periodically. Additionally, or alternatively, the preprocessor 303 and/or the AI classifier 305 are configured to analyze and classify the audio signal 302 when the audio signal 302 is first received. Additionally, or alternatively, the preprocessor 303 and/or the AI classifier 305 are configured to continuously analyze and classify the audio signal 302.

In some aspects, the preprocessor 303 and/or the AI classifier 305 are configured to use other information to analyze and classify the audio signal 302. For example, the preprocessor 303 and/or the AI classifier 305 are configured to use metadata associated with the audio signal 302 to analyze and classify the audio signal. Additionally, or alternatively, the preprocessor 303 and/or the AI classifier 305 are configured to use input(s) from user(s) to analyze and classify the audio signal 302. However, the preprocessor 303 and/or the AI classifier 305 can use other data or information to further analyze and classify the audio signal 302. In a non-limiting example, the metadata associated with the audio signal 302 can be used for a first classification. Then, the preprocessor 303 and/or the AI classifier 305 are used for further fine-tuning the classification of the audio signal.

According to some aspects, the audio signal 302 can include multiple modes/profiles during time. The preprocessor 303 and/or the AI classifier 305 is configured to determine and change the classification of the audio signal 302 in time. For example, the audio signal 302 can be associated with a video content that includes speech, music, and dialogue. The preprocessor 303 and/or the AI classifier 305 are configured to determine these three modes within the audio signal 302 and generate the corresponding classification for each portion of the audio signal 302. In other words, the preprocessor 303 and/or the AI classifier 305 is configured to determine a plurality of audio classes for the audio signal 302, where each one of the plurality of audio classes is associated with a portion of the audio signal 302 in time.

According to some aspects, the audio classifier 222 outputs the audio class(es) 307 and the audio signal 309. In some aspects, the audio class(es) 307 and the audio signal 309 can be input to the audio processor 224 and/or the audio decoder 212. The audio processor 224 and/or the audio decoder 212 use the audio class(es) 307 to perform further processing (e.g., the audio quality (AQ) enhancement using digital signal processing (DSP) algorithms) on the audio signal 309. Additionally, or alternatively, the audio class(es) 307 can change the audio mode/profile on media device 106 and/or display device 108 for playing the audio signal 309 (or the processed audio signal 309 processed by the audio processor 224 and/or the audio decoder 212). In some aspects, the audio signal 309 can be the same as the audio signal 302. In some aspects, the audio signal 309 can be the different from the audio signal 302. For example, the audio signal 309 can be the same as preprocessed audio signal 304 or other audio signal derived from the audio signal 302.

Although the audio classifier 222 is discussed with respect to the media device 106, the audio classifier 222 can be deployed on one or more of the media device 106, the display device 108, the remote controller 110, the system server 126, and/or the content server 120.

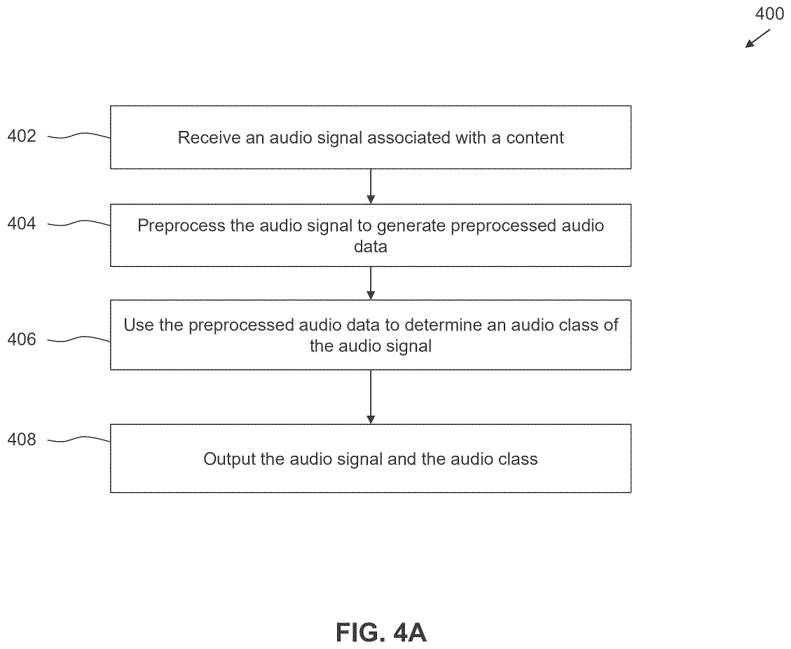

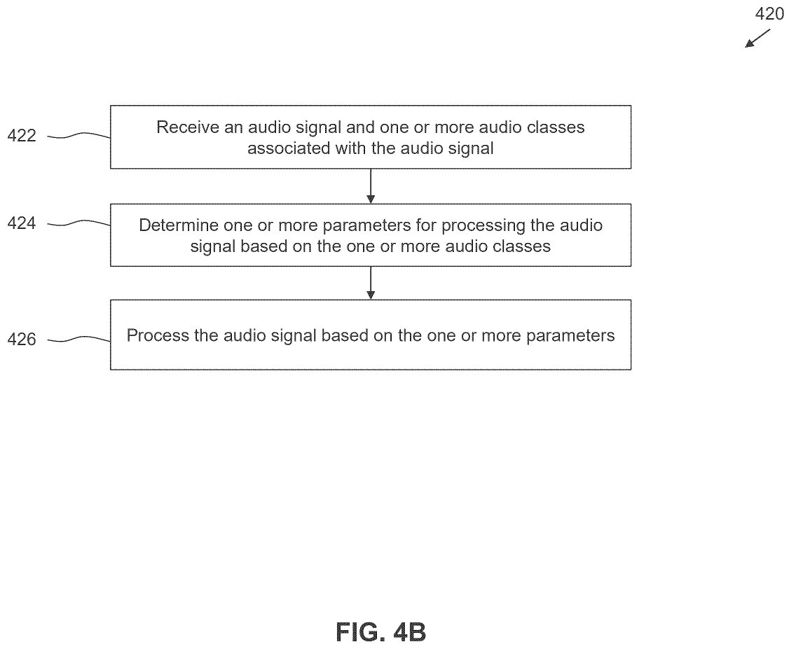

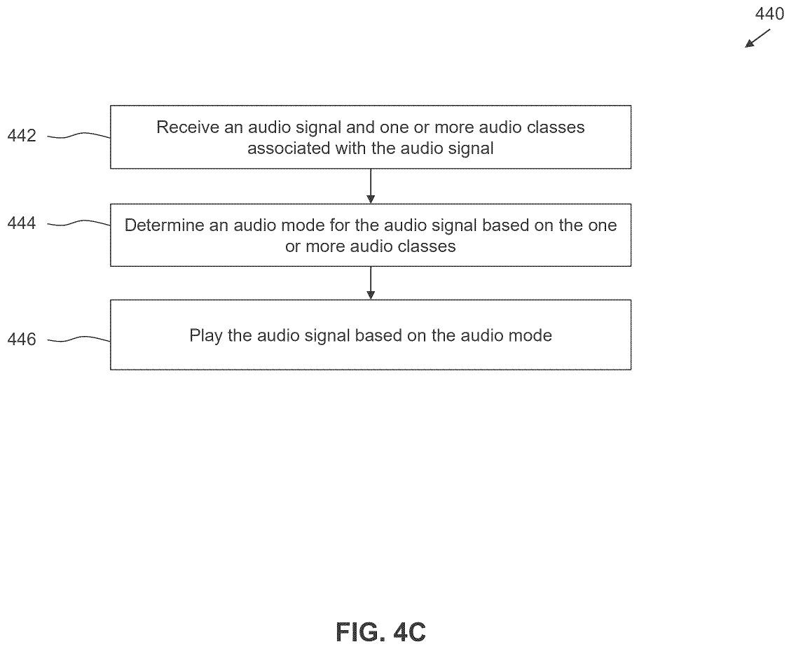

FIG. 4A is a flowchart for a method 400 for classifying audio signals, according to some aspects. Method 400 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4A, as will be understood by a person of ordinary skill in the art.

Method 400 shall be described with reference to FIGS. 1-3. However, method 400 is not limited to that example aspect. According to some aspects, method 400 can be performed by the audio classifier 222 of FIGS. 2 and 3.

At 402, an audio signal is received. For example, the audio classifier 222 of FIG. 3 receives the audio signal 302 from the audio source 301. The audio signal can be associated with a content such as, but not limited to, an audio content, a video content, or the like. The audio signal can include one or more audio modes/profiles such as music, speech, sports, theatre, dialogue, or the like.

At 404, the audio signal is preprocessed. The audio signal is preprocessed to generate preprocessed audio data. For example, the preprocessor 303 of FIG. 3 processes the audio signal 302 to generate the preprocessed audio signal 304. In some aspects, preprocessing the audio signal can include generating one or more audio samples from the audio signals. Additionally, or alternatively, preprocessing the audio signal can include converting the audio signal (and/or the audio samples) from time-domain to frequency domain. Additionally, or alternatively, preprocessing the audio signal can include generating spectrogram (e.g., a one dimensional array data) associated with the audio signal. However, the preprocessing the audio signal can include other processing operation(s) to prepare the audio signal for classification.

At 406, the preprocessed audio data is used for classifying the audio signal. The preprocessed audio data is used to determine one or more audio classes for the audio signal. For example, the AI classifier 305 can use the preprocessed audio data (e.g., the preprocessed audio signal 304) to determine (e.g., generate) one or more audio classes 307. According to some aspects, the AI classification of the preprocessed audio data can include using one or more GRU blocks to classify the preprocessed audio data. Additionally, or alternatively, the AI classification of the preprocessed audio data can include determining the number of the GRU blocks used for classification. Additionally, or alternatively, the AI classification of the preprocessed audio data can include dynamically changing the number of GRU block for classification. Additionally, or alternatively, the AI classification of the preprocessed audio data can include using metadata (or other information associated with the audio signal) for classification.

At 408, the one or more classifications and/or the audio signal are output. For example, the AI classifier 305 can output the one or more audio classes 307 and/or the audio signal 309. The one or more classifications can be used by the media device 106 and/or the display device 108 of FIG. 1 to choose and/or modify the audio mode/profile used to play the audio signal. Additionally, or alternatively, one or more classifications can be used for further processing the audio signal. For example, the one or more classifications can be used for selecting DSP algorithm(s) used for AQ enhancement. Additionally, or alternatively, the one or more classifications can be used for adapting the parameters of DSP algorithm(s) used for AQ enhancement.

According to some aspects, method 400 can be performed once on the audio signal. Additionally, or alternatively, method 400 can be performed repeated periodically and/or continuously. For example, method 400 can be performed on one or more portions of the audio signal. In some aspects, each portion of the audio signal may generate a different audio class.

According to some aspects, method 400 can also include training and/or re-training the AI classifier (e.g., the AI classifier 305). For example, before the audio classifier 222 is deployed on, for example, the media device 106 and/or the display device 108, the AI classifier 305 is trained. Additionally, or alternatively, the AI classifier 305 is trained and/or re-trained while the AI classifier 305 is operating on the media device 106 and/or the display device 108. For example, the same audio signal that is being classified by the AI classifier 305 can be used to re-train (or update) the AI classifier 305. For example, the AI classifier 305 can be re-trained based on the feedback that the users of the media device 106 and/or the display device 108 provide based on, for example, the selected audio mode/profile of the media device 106 and/or the display device 108 resulted from the classification.

FIG. 4B is a flowchart for a method 420 for processing audio signals, according to some aspects. Method 420 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4B, as will be understood by a person of ordinary skill in the art.

Method 420 shall be described with reference to FIGS. 1-3. However, method 420 is not limited to that example aspect. According to some aspects, method 420 can be performed by the audio processor 224 and/or the audio decoder 212 of FIG. 2.

At 422, an audio signal and one or more audio classes associated with the audio signal are received. For example, the audio processor 224 and/or the audio decoder 212 of FIG. 2 receive the one or more audio classes 307 and the audio signal 309.

At 424, one or more parameters for processing the audio signal are determined based on the one or more audio classes. For example, the audio processor 224 and/or the audio decoder 212 can determine one or more parameters for processing the audio signal 309 based on the one or more audio classes 307. In some aspects, the one or more audio classes are used to select DSP algorithm(s) used for AQ enhancement. For example, the one or more audio classes are used to select a DSP algorithm from a plurality of DSP algorithms that would best enhance the audio signal (e.g., the AQ enhanced audio signal satisfies a condition, a quality parameter of the enhanced audio signal satisfies a threshold, or the like). Additionally, or alternatively, the one or more audio classes can be used for selecting and/or adapting the parameters of DSP algorithm(s) used for AQ enhancement. For example, the one or more audio classes are used to select or adjust one or more parameters of a DSP algorithm for enhancing the audio signal. For example, the one or more audio classes are used to select or adjust one or more parameters of the DSP algorithm such that the AQ enhanced audio signal satisfies a condition, a quality parameter of the enhanced audio signal satisfies a threshold, or the like.

At 426, the audio signal is processed based on the one or more parameters. For example, the audio processor 224 and/or the audio decoder 212 can use the one or more parameters for processing the audio signal 309. For example, the audio processor 224 and/or the audio decoder 212 can use the selected DSP algorithm(s) for AQ enhancement of the audio signal. Additionally, or alternatively, the audio processor 224 and/or the audio decoder 212 can use the selected and/or adapted the parameters of DSP algorithm(s) for AQ enhancement of the audio signal.

FIG. 4C is a flowchart for a method 440 for setting an audio mode, according to some aspects. Method 440 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4C, as will be understood by a person of ordinary skill in the art.

Method 440 shall be described with reference to FIGS. 1-3. However, method 440 is not limited to that example aspect. According to some aspects, method 440 can be performed by the media device 106, the display device 108, and/or the remote control 110 of FIG. 1.

At 442, an audio signal and one or more audio classes associated with the audio signal are received. For example, the media device 106, the display device 108, and/or the remote control 110 of FIG. 1 receive the one or more audio classes 307 and/or the audio signal 309. For example, the media device 106 and/or the display device 108 can receive both the one or more audio classes 307 and the audio signal 309. However, the remote control 110 can receive the one or more audio classes 307.

At 444, an audio mode/profile for the audio signal is determined based on the one or more audio classes. For example, the media device 106, the display device 108, and/or the remote control 110 can determine the audio mode/profile for the audio signal 309 based on the one or more audio classes 307.

At 446, the audio signal is played based on the determined audio mode/profile. For example, the media device 106 and/or the display device 108 can play the audio signal 309 based on the determine audio mode. Additionally, or alternatively, the remote control 110 can transmit the determine audio mode/profile to the media device 106 and/or the display device 108, where the media device 106 and/or the display device 108 play the audio signal 309 based on the determine audio mode.

### Example Computer System

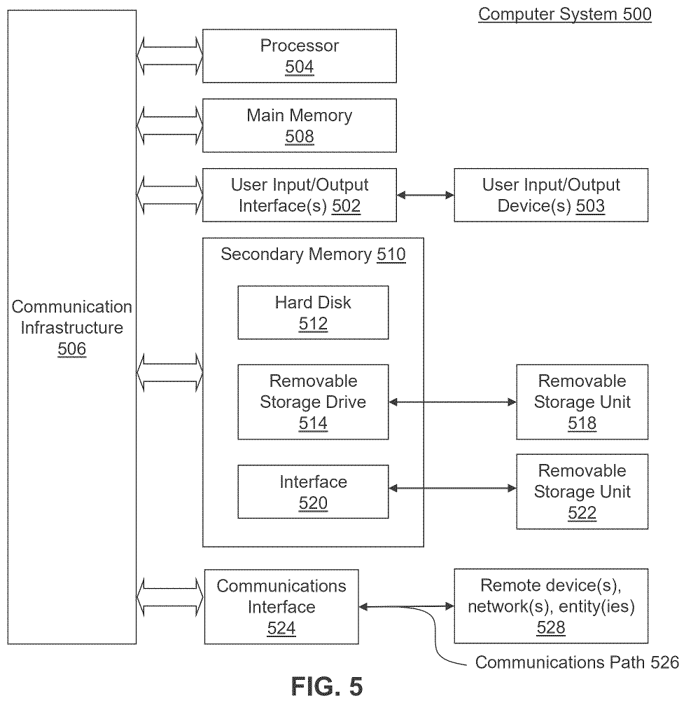

Various aspects may be implemented, for example, using one or more computer systems, such as computer system 500 shown in FIG. 5. For example, the audio classifier 222 may be implemented using combinations or sub-combinations of computer system 500. Additionally, or alternatively, the audio processor 224 may be implemented using combinations or sub-combinations of computer system 500. Also or alternatively, one or more computer systems 500 may be used, for example, to implement any of the aspects discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500 or processor(s) 504), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 5. In particular, aspects can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

1. A computer-implemented method, comprising:
receiving, by at least one computer processor, an audio signal associated with a content, wherein the audio signal includes a plurality of audio classes and wherein each one of the plurality of audio classes is associated with a portion of the audio signal in time;
preprocessing the audio signal to generate preprocessed audio data;
determining the plurality of audio classes using the preprocessed audio data, wherein each one of the plurality of audio classes indicates a corresponding audio mode for playing the corresponding portion of the audio signal; and
outputting the audio signal and the plurality of audio classes.

2. The computer-implemented method of claim 1, wherein determining the plurality of audio classes comprises using an artificial intelligence (AI) classification model to classify the preprocessed audio data and to determine the plurality of audio classes.

3. The computer-implemented method of claim 2, wherein the AI classification model comprises one or more gated recurrent unit (GRU) blocks.

4. The computer-implemented method of claim 3, wherein determining the plurality of audio classes further comprises determining a number of the one or more GRU blocks used for classifying the preprocessed audio data.

5. The computer-implemented method of claim 1, wherein preprocessing the audio signal comprises at least one of generating audio samples from the audio signal, converting the audio signal from a time-domain to a frequency domain, or generating a spectrogram associated with the audio signal.

6. The computer-implemented method of claim 1, wherein each one of the plurality of audio classes is used to determine one or more parameters for processing the audio signal after the audio classification.

7. The computer-implemented method of claim 1, wherein each one of the plurality of audio classes is used to select a digital signal processing (DSP) algorithm for audio quality (AQ) enhancement of the audio signal.

8. The computer-implemented method of claim 1, wherein each one of the plurality of audio classes is used to select one or more parameters of a digital signal processing (DSP) algorithm for audio quality (AQ) enhancement of the audio signal.

9. The computer-implemented method of claim 1, wherein each one of the plurality of audio classes is used to select the corresponding audio mode of a media device or the corresponding audio mode of a display device for playing the audio signal.

10. The computer-implemented method of claim 1, wherein determining each one of the plurality of audio classes comprises using an artificial intelligence (AI) classification model in addition to metadata associated with the audio signal to classify the preprocessed audio data and to determine the plurality of audio classes.

11. (canceled)

12. A non-transitory computer-readable medium having instructions stored thereon that, when executed by at least one computing device, cause the at least one computing device to perform operations comprising:
receiving an audio signal associated with a content, wherein the audio signal includes a plurality of audio classes and wherein each one of the plurality of audio classes is associated with a portion of the audio signal in time;
preprocessing the audio signal to generate preprocessed audio data;
determining the plurality of audio classes using the preprocessed audio data, wherein each one of the plurality of audio classes indicates a corresponding audio mode for playing the corresponding portion of the audio signal and wherein the corresponding audio mode comprises at least one of a music mode, a speech mode, a sports mode, a theatre mode, or a dialogue mode; and
outputting the audio signal and the plurality of audio classes.

13. The non-transitory computer-readable medium of claim 12, wherein determining the plurality of audio classes comprises using an artificial intelligence (AI) classification model that comprises one or more gated recurrent unit (GRU) blocks to classify the preprocessed audio data and to determine the plurality of audio classes.

14. The non-transitory computer-readable medium of claim 13, wherein determining the plurality of audio classes further comprises determining a number of the one or more GRU blocks used for classifying the preprocessed audio data.

15. The non-transitory computer-readable medium of claim 12, wherein preprocessing the audio signal comprises at least one of generating audio samples from the audio signal, converting the audio signal from a time-domain to a frequency domain, or generating a spectrogram associated with the audio signal.

16. The non-transitory computer-readable medium of claim 12, each one of the plurality of audio classes is used to select a digital signal processing (DSP) algorithm for audio quality (AQ) enhancement of the audio signal.

17. The non-transitory computer-readable medium of claim 12, wherein each one of the plurality of audio classes is used to select one or more parameters of a digital signal processing (DSP) algorithm for audio quality (AQ) enhancement of the audio signal.

18. The non-transitory computer-readable medium of claim 12, wherein each one of the plurality of audio classes is used to select the audio mode of a media device or the corresponding audio mode of a display device for playing the audio signal.

19. The non-transitory computer-readable medium of claim 12, wherein determining each one of the plurality of audio classes comprises using an artificial intelligence (AI) classification model in addition to metadata associated with the audio signal to classify the preprocessed audio data and to determine the plurality of audio classes.

20. A system, comprising:
one or more memories; and
at least one processor each coupled to at least one of the one or more memories and configured to perform operations comprising:
receiving an audio signal associated with a content, wherein the audio signal includes a plurality of audio classes and wherein each one of the plurality of audio classes is associated with a portion of the audio signal in time;
preprocessing the audio signal to generate preprocessed audio data;
determining the plurality of audio classes using the preprocessed audio data, wherein each one of the plurality of audio classes class indicates a corresponding audio mode for playing the corresponding portion of the audio signal and wherein the corresponding audio mode comprises at least one of a music mode, a speech mode, a sports mode, a theatre mode, or a dialogue mode; and
outputting the audio signal and the plurality of audio classes
